(19) United States
(12) Patent Application Publication
(10) Pub. No.: US 2008/0037171 A1
(43) Pub. Date: Feb. 14, 2008

(54) Avoiding superparamagnetic trap by changing grain geometries in heat-assisted magnetic recording systems

(75) Inventors: Sonali Mukherjee, Pittsburgh, PA (US); Julius Hohlfeld, Wexford, PA (US); Bin Lu, Pittsburgh, PA (US); Dieter K. Weller, San Jose, CA (US)

Correspondence Address: SEAGATE TECHNOLOGY LLC C/O WESTMAN;CHAMPLIN & KELLY, P.A., SUITE 1400, 900 SECOND AVENUE SOUTH, MINNEAPOLIS, MN, 55402-3319, US

(73) Assignee: Seagate Technology LLC, Scotts Valley, CA (US)

(21) Appl. No.: 11/500,625

(22) Filed: Aug. 8, 2006

(51) Int. Cl. G11B 5/74; G11B 5/64

(52) U.S. Cl. 360/131; 428/826; 428/836.1

(57) ABSTRACT

A data storage medium for perpendicular recording has a substrate and a ferromagnetic layer on the substrate for storing data bits. The ferromagnetic layer has a plurality of elongate grains of magnetizable material extending perpendicular to the substrate which form magnetic domains representative of data. Each magnetic domain is separated from adjacent magnetic domains by a bit edge domain wall region. Each elongate grain has a perpendicular height that is greater than a width of the bit edge domain wall region.

### GOVERNMENT RIGHTS

This invention was made with United States Government support under Agreement No. 70NANB1H3056 awarded by the National Institute of Standards and Technology (NIST). The United States Government has certain rights in the invention.

### FIELD OF THE INVENTION

The present invention generally relates to data storage devices, and more particularly to heat-assisted magnetic recording devices and associated storage media.

### BACKGROUND OF THE INVENTION

Generally, data storage devices are designed to store as much data as possible on a storage medium. Areal density is a measure of data storage capacity that refers to a number of bits per unit area on the storage medium, typically measured in bits per square inch. Since magnetic recording devices were first introduced, storage capacity has increased exponentially, in part, by decreasing the size of the magnetic grains that store the data bits on the storage medium.

In perpendicular recording, for example, data bits are written to the storage medium by applying a controlled magnetic field to a magnetizable layer of the data storage medium to orient a magnetic direction (North/South) of the magnetic grains in a local region of the storage medium. A region of the storage medium material where all of the magnetic grains are oriented in the same direction is called a domain, and each domain stores a bit of information. Adjacent domains are separated from one another by a finite region, called a domain wall, in which the direction of magnetization changes from one direction to another. A domain can include one or more magnetic grains. By making each magnetic grain smaller, more grains can occupy the same unit area, and thereby increase the areal density of the storage medium.

Unfortunately, as the magnetic grains become smaller and smaller to increase the data density, the grains also become increasingly susceptible to random thermal fluctuations at room temperature, causing the grains randomly and spontaneously to reverse their magnetic orientations, thereby losing the stored data bits and rendering the storage device unreliable. This spontaneous reversal of magnetic orientations is referred to as the superparamagnetic effect.

The exact areal density where the superparamagnetic effect occurs is partially dependent on the anisotropy of the material. The term anisotropy refers to the tendency for magnetic materials to be magnetized in certain directions. Changing the magnetic direction (orientation) of a material with high anisotropy requires a lot of energy, so exposure to low magnetic fields is insufficient to trigger magnetic changes. Thus, using materials with high anisotropy for data recording provides magnetic stability. For thermal stability, materials with high crystalline anisotropy, such as Iron-Platinum (FePt), are being considered.

To write data to a storage medium formed of a material with high anisotropy, conventional magnetic write fields are not sufficient to write data. To overcome the high anisotropy, the read-write mechanism uses heat to lower the energy barrier of the material, in addition to a magnetic field. Once the magnetic grains are heated, the direction of magnetism of the magnetic grains can then be changed using the magnetic field. After the heat source is removed, the system cools and the crystalline anisotropy of the magnetic grain is restored.

Unfortunately, the probability that the high anisotropy grains will randomly and spontaneously reverse polarity (magnetic direction) is sensitive to grain size and cooling rate. For high cooling rates and small grain sizes, the final state of the grain's magnetic poles is determined by initial thermal fluctuations, and an external field much smaller than the reversal field at room temperature (Hₖ₀) has no influence. The chance of reversing each grain is approximately 50 percent, and magnetization averaged over all the grains is approximately zero. This behavior is sometimes referred to as the superparamagnetic trap.

While reduction of the cooling rate reduces the probability of falling into the superparamagnetic trap, thermal fluctuations during cooling can erase the effect of the field. Moreover, slowed cooling results in a corresponding broadening of the grain temperature profile, which hinders the goal of higher areal densities by increasing the area in which the magnetic field can impact the magnetic orientation. Further, slowing down the cooling rate can adversely effect the data rate of a storage device. Thus, there is an on-going need for a high density data storage medium that allows for fast cooling without falling into the superparamagnetic trap. Embodiments of the present invention provide solutions to these and other problems, and offer other advantages over the prior art.

### SUMMARY OF THE INVENTION

A data storage medium for perpendicular recording has a substrate and a ferromagnetic layer on the substrate for storing data bits. The ferromagnetic layer has a plurality of elongate grains of magnetizable material extending perpendicular to the substrate. One or more grains have a shared direction of magnetization that defines a magnetic domain representative of a data bit. The magnetic domain is separated from adjacent magnetic domains by a domain wall region, over which a direction of magnetization changes from the shared direction to another direction. Each elongate grain has a perpendicular height that is greater than a width of the domain wall region.

In one embodiment, the ferromagnetic layer is formed from a material having a high anisotropy. In another embodiment, the data storage medium is used within a data storage device having a heat-assisted read-write mechanism adapted to lower the anisotropy of the ferromagnetic layer for magnetic recording.

Other features and benefits that characterize embodiments of the present invention will be apparent upon reading the following detailed description and review of the associated drawings.

### BRIEF DESCRIPTION OF THE DRAWINGS

FIG. 1 is an isometric view of a disc drive on which embodiments of the present invention may be employed.

FIG. 2 is a simplified block diagram of an elongate magnetic grain according to an embodiment of the present invention.

FIG. 3 is a simplified diagram of an atom with a single electron orbiting a nucleus.

FIG. 4 is a simplified flow diagram of a process for orienting a magnetic grain using heat and an applied magnetic field.

FIG. 5 is a simplified perspective view of a plurality of oriented magnetic grains representing data bits within a portion of a storage medium.

FIG. 6 is a simplified cross-sectional block diagram of a portion of a storage medium formed from a plurality of elongate magnetic grains according to an embodiment of the present invention.

FIG. 7 is a simplified cross-sectional view of a portion of a read/write transducer for perpendicular recording.

FIG. 8 is a simplified block diagram of a heat-assisted storage device for heat-assisted perpendicular recording.

FIGS. 9A and 9B are graphs illustrating the average magnetization of atoms in the z-plane (M_{z}) divided by the saturation value of the z-component magnetization at room temperature (Mₛ) of various grains plotted with respect to atomic layers in the z-direction where initial fluctuations are in a direction of an external field.

FIGS. 10A and 10B are graphs illustrating M_{z} divided by the saturation value of the z-component magnetization at room temperature (Mₛ) of various grains plotted with respect to atomic layers in the z-direction where initial fluctuations are in a direction opposite to an external field.

FIGS. 11A-11C are a series of graphs of M_{z} divided by the saturation value of the z-component magnetization at room temperature (Mₛ) for a grain having a length of 60 atoms, showing evolution of thermal fluctuations into multiple domains and reversal by domain wall propagation over time.

FIG. 12 is a graph of coercivity (Hc) versus magnetic layer thickness for a series of media having column-shaped magnetic grains.

FIG. 13 is a graph of squareness versus magnetic layer thickness for the series of media of FIG. 9.

### DETAILED DESCRIPTION OF ILLUSTRATIVE EMBODIMENTS

In general, embodiments of the present invention utilize ferromagnetic grains of an elongate shape for storing data. Preferably, the elongate grains have a length (height) that is greater than a domain wall width. By controlling the grain geometry, the superparamagnetic trap can be avoided.

An embodiment of the present invention includes a data storage medium having a ferromagnetic layer formed with columnar grains (sometimes referred to as elongate grains or acicular grains). Each columnar grain has a grain size that is larger than a width of a domain wall between adjacent data bits on the storage medium. By making the grain size larger than the domain wall width, the grain is large enough to contain a domain wall. One or more domain walls can be nucleated in the grain, and magnetization reversal within the grain occurs by domain wall propagation, rather than coherent rotation. Domain wall propagation allows for magnetic reversal in such grains while avoiding the superparamagnetic trap, even for fast cooling rates. As long as one domain in the direction of the external field is stabilized, the domain can expand under the action of the external field. This allows for magnetic medium formation with very high aerial densities without data loss due to random switching of bits.

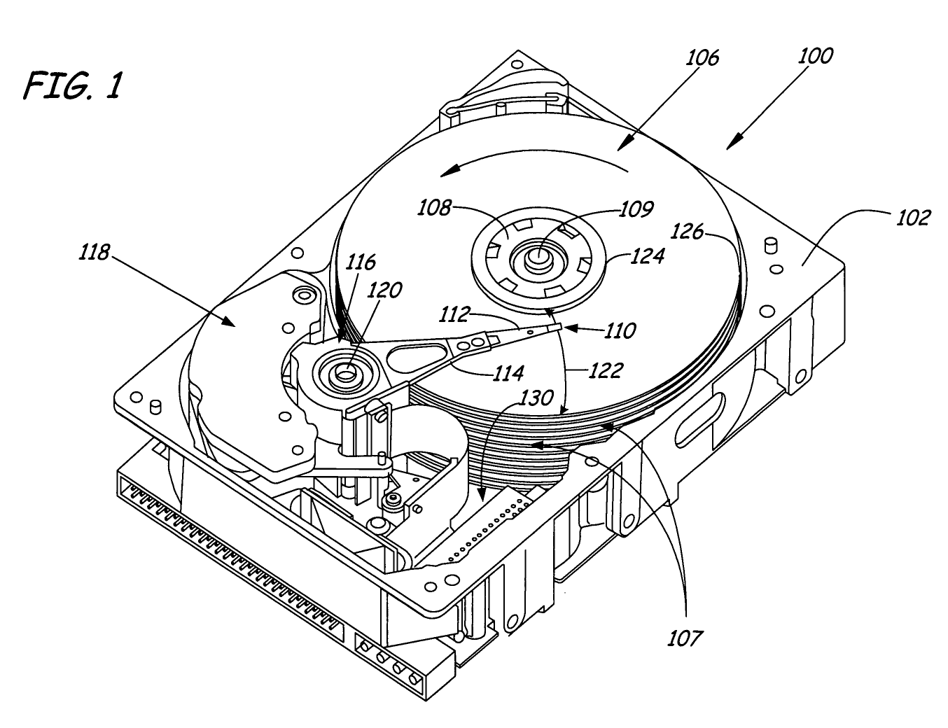

FIG. 1 is an isometric view of a disc drive 100 in which embodiments of the present invention are useful. Disc drive 100 includes a housing with a base 102 and a top cover (not shown). Disc drive 100 further includes a disc pack 106, which is mounted on a spindle motor (not shown) by a disc clamp 108. Disc pack 106 includes a plurality of individual discs, which are mounted for co-rotation about central axis 109. Each disc surface has an associated disc head slider 110 which is mounted to disc drive 100 for communication with the disc surface. In the example shown in FIG. 1, heads 110 are supported by sliders that are mounted to suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track along an arcuate path 122 between a disc inner diameter 124 and a disc outer diameter 126. Voice coil motor 118 is driven by servo electronics 130 based on signals generated by heads 110 and a host computer (not shown).

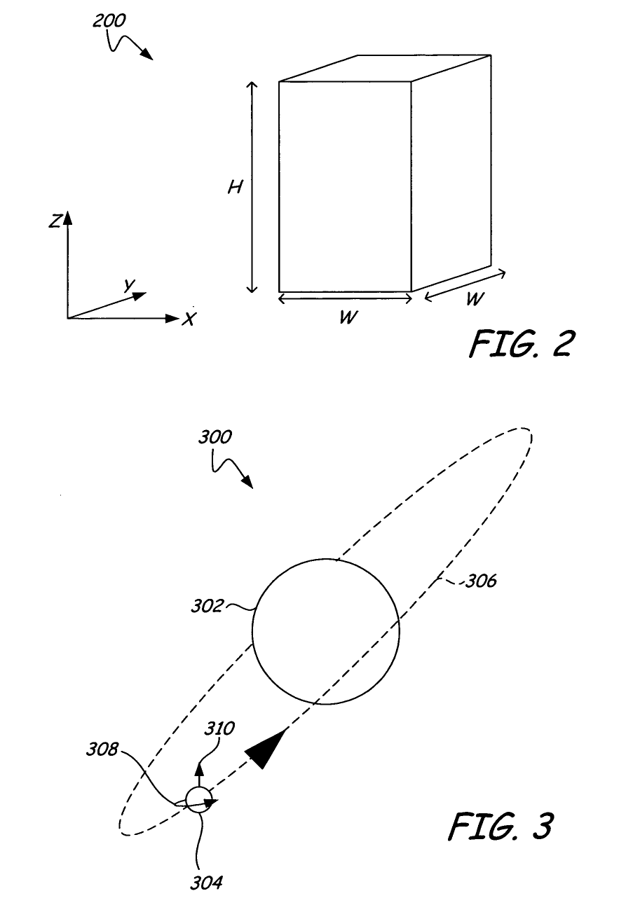

FIG. 2 is an isometric view of a magnetizable, columnar grain 200, which is generally formed from a material having a high crystalline anisotropy, such as Iron-Platinum (FePT) alloy or Cobalt-Platinum (CoPt) alloy, for example. Grain 200 has a width (W) and a height (H). In general, the width (W) of the grain 200 determines the areal density of the storage medium. A high areal density (such as one Terrabit per square inch) necessitates a reduction of grain cross-section to length scales of three to ten nanometers. For example, the grain 200 can have a width (W) of three nanometers and a height (H) of 20 nanometers, resulting in a 3×3×20 grain volume. While the grain 200 is shown as a rectangular structure, it should be understood by worker skilled in the art that the grain 200 is presented for illustrative purposes only. Grain 200 may be cylindrical or may be irregular in shape provided that the perpendicular height of the grain 200 is greater than a domain wall width between magnetic domains.

FIG. 3 is a simplified diagram of an atom 300. To understand magnetic direction, it is important to understand atomic spin. Atom 300 includes a nucleus 302 and a single orbiting electron 304. Atoms 300 typically contain many electrons 304. Each electron 304 moves in its own orbital path 306 and each spins about its own axis (as indicated by arrow 308). The magnetic moment associated with the orbit and rotation of the electron 304 are both vector quantities, normal to the plane of the orbit and parallel to the axis of spin, respectively. The magnetic moment of any given atom 300 is the vector sum of all of its electronic moments. If the magnetic moments of all the electrons of an atom are oriented such that they cancel each other out, then the atom 300 has no net magnetic moment. However, if the cancellation of electronic moments is only partial, the atom 300 is left with a net magnetic moment. In this instance, atom 300 has a net magnetic moment 310 due to the electron spin. Substances composed of atoms of this kind are paramagnetic, ferromagnetic, antiferromagnetic, or ferrimagnetic.

Magnetocrystalline anisotropy refers to a crystalline property whereby the orientations of the orbits of the electrons of the various atoms within the crystal structure are fixed very strongly to the crystalline lattice, such that even large applied magnetic fields cannot change their spin or orbits. The resistance to fields is due mainly to spin-orbit coupling (interaction). This type of coupling keeps neighboring spins parallel or antiparallel to one another.

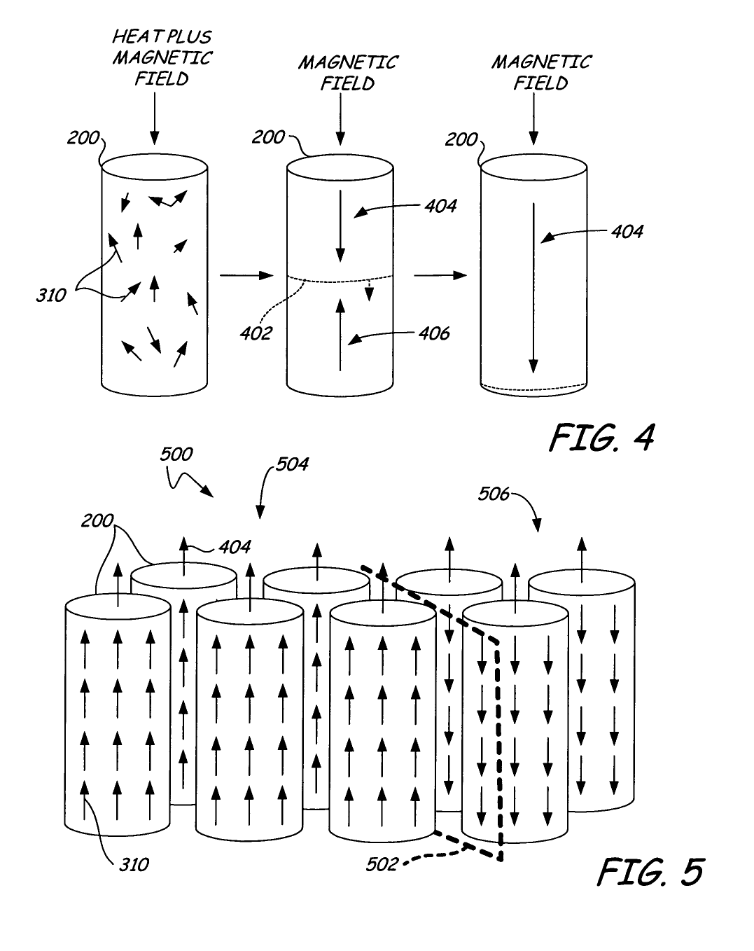

FIG. 4 is a simplified flow diagram of a process 400 for changing a magnetic direction of a magnetic grain 200 with high magnetocrystalline anisotropy. The magnetic grain 200 is includes a plurality of atoms, some of which may contribute a net magnetic moment 310. Initially heat and a magnetic field are applied to the grain 200. The heat source is removed and the grain 200 is allowed to cool in the presence of the magnetic field. A domain wall 402 forms within the grain 200. As the domain wall 402 propagates, the net magnetic moments 310 in the direction of the magnetic field (as indicated by arrow 404). Other magnetic moments 310 remain unaligned with the magnetic field (as indicated by arrow 406), until the domain expands under the influence of the external field, orienting the magnetic moments of the atoms within the grain in the direction of the field. Thus, reversal of magnetic direction within such grains (where the length or height of the grain is greater than a domain wall width) occurs by domain wall propagation, not coherent rotation.

FIG. 5 is a simplified block diagram of a data pattern 500 within a plurality of such grains. Each grain 200 has a net magnetic moment 404 corresponding to a sum of a plurality of vectors of magnetic moments 310 within each grain 200. In this instance, the grains 200 store data, which is represented by the magnetic moments of the various grains 200 within a particular domain 504,506 or local area. Each domain 504,506 is magnetized to the saturation value (Mₛ) in a particular direction representative of its associated data bit. The domains 504,506 are separated by a bit edge domain wall 502. In one instance, domain 504 represents a value of one, while domain 506 represents a value of zero. Though the magnetic moments 310 are shown to be identically oriented within each grain, in practice there are variations, but the net magnetic moment of each grain is oriented in the direction of the applied magnetic field (as shown in FIG. 4).

In general, the bit edge domain wall 502 represents a finite interface or region between magnetic domains 504,506. At or within the domain wall 502, the direction of magnetization changes. In general, the exchange energy in a ferromagnetic material is a minimum only when adjacent spins are parallel, so changes in spin direction take place over a finite region. The spins of electrons associated with atoms within the domain wall 502 point in different directions, and the crystal anisotropy energy within the domain wall 502 is greater than that of the adjoining domains. The exchange energy and the anisotropy energy cooperate to confine the domain wall 502 to a finite width and to a certain structure.

In general, to achieve higher densities, the grain sizes are reduced to increase the number of grains per unit area on the storage medium. Atomic scale simulations shown in Table 1 illustrate that smaller grain sizes reverse magnetization less reliably than larger grain sizes.

TABLE 1

| | Hₑₓₜ/Hₖ₀ = 0.25 | Hₑₓₜ/Hₖ₀ = 0.1 | Hₑₓₜ/Hₖ₀ = 0.5 | |
|---|---|---|---|---|
| | for a few | after a few | after a few | |
| Grain Size | picoseconds | nanoseconds | nanoseconds | Analysis |
| 3 × 3 × 3 nm³ | 16/30 | 15/30 | 15/30 | Approximatel 50% |
| | | | | reversal |
| | | | | (superparamagnetic |
| | | | | behavior) |
| 10 × 10 × 10 nm³ | 18/30 | 15/30 | 15/30 | Approximately 50% |
| | | | | reversal |
| | | | | (superparamagnetic |
| | | | | behavior) |
| 3 × 3 × 20 nm³ | 29/30 | 30/30 | 30/30 | Almost 100% reversal |
| | | | | dictated by external field |

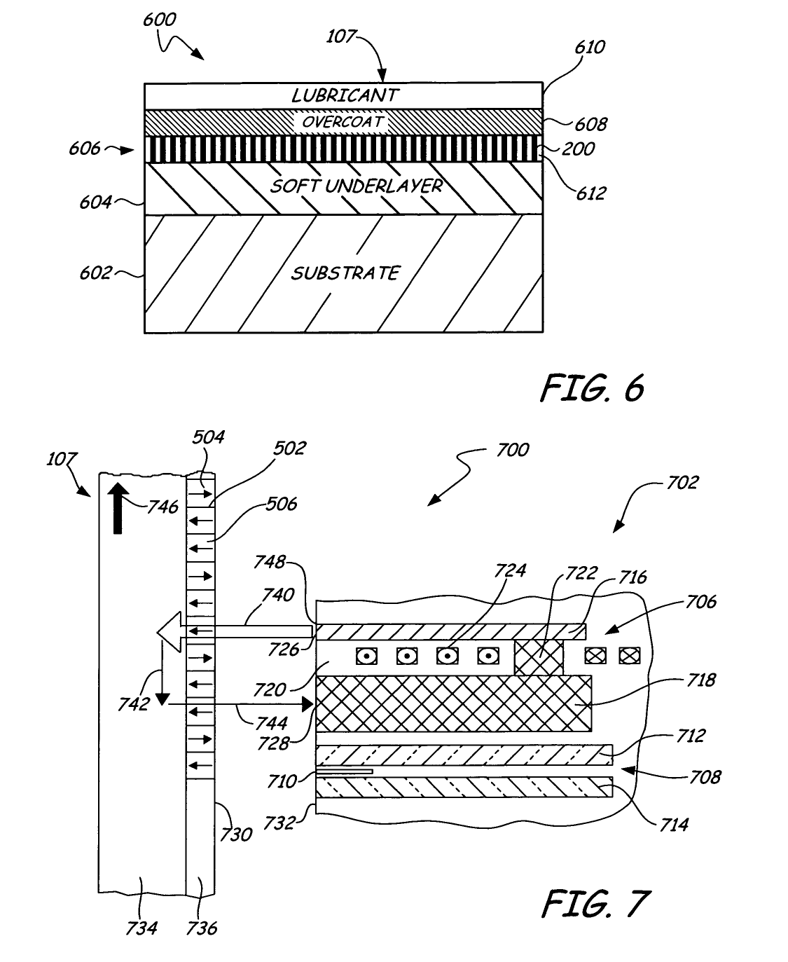

For small grain sizes undergoing fast (picosecond) cooling, the magnetization evolution is determined by the reversal field (Hₖ₀), and the external magnetic field field (Hₑₓₜ) has no influence. For grain sizes smaller than a single domain, the possibility of nucleating a domain in the direction of the external field (Hₑₓₜ) is approximately 50 percent. The possibility depends on initial fluctuations, which do not have a preferred direction at high temperatures (as shown in FIGS. 6A-7B below). This is an example of the superparamagnetic trap. Out of 30 configurations examined, 29 configurations had reversed when H/H_{K0}=0.25. For grain sizes larger than a single domain size, multiple domains nucleate. This increases the chances of nucleating a domain in the direction of the external field (Hₑₓₜ). The domain then expands under the influence of the external field until the magnetization direction of the entire grain reverses. This demonstrates that elongated grains allow for nearly 100% magnetization averaged over the grains. Thus, the superparamagnetic trap can be avoided by elongating the grain.

In traditional data recording, with densities much smaller than 1 Terrabyte per square inch, the important energy scales in the system are a) Exchange energy and b) Magnetostatic energy. The crystalline anisotropy is much smaller than the magnetostatic interactions and for the most part does not play any significant role in the dynamics and statics of the system. The important length scale in this case is the exchange length, which arises from the competition of the exchange and the magnetostatic interaction energies.

For high data storage densities, the grain sizes have to be reduced and for thermal stability the crystalline anisotropy has to be increased. For these kinds of media the important energy scales are a) Exchange and b) Crystalline anisotropy. Again, the magnetostatic interactions do not play an important role especially for the sizes of interest which are single domain. In these cases, the important length scale is given by the competition between exchange and crystalline anisotropy, such that the domain wall width is as follows:

$${L}_{dw} ∼ π \sqrt{\frac{J}{k}} , \qquad ( 1 )$$

where J is the exchange constant and k is the crystalline anisotropy. Both the exchange constant and the crystalline anisotropy are defined at the atomic scale. For example, the domain wall width for FePt is approximately 3 nm.

Based on the above atomic scale simulations, domain wall propagation overcomes the supermagnetic trap when the perpendicular grain height (h) is larger than the domain wall width (L_{dw}), which is set by the material properties to be π\sqrt{J/K}. Thus, a magnetic material such as FePt or CoPt can be used for heat-assisted magnetic recording such that the magnetization of the magnetic domains switches by wall propagation (motion) when the grain height in the magnetic material exceeds the domain wall width as follows:

h>π\sqrt{J/K}. tm (2)

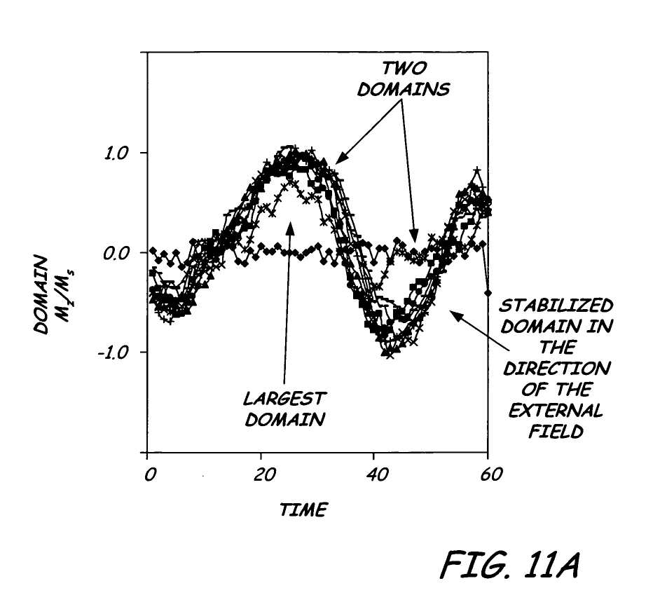

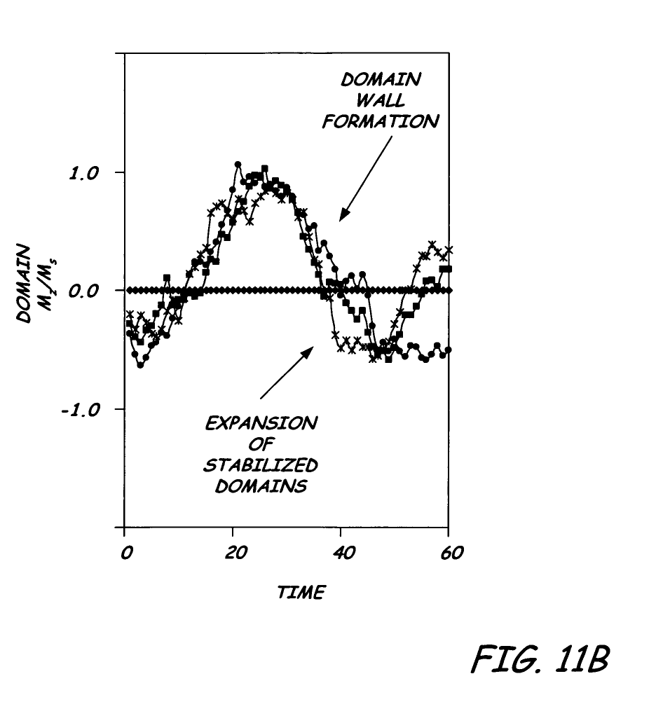

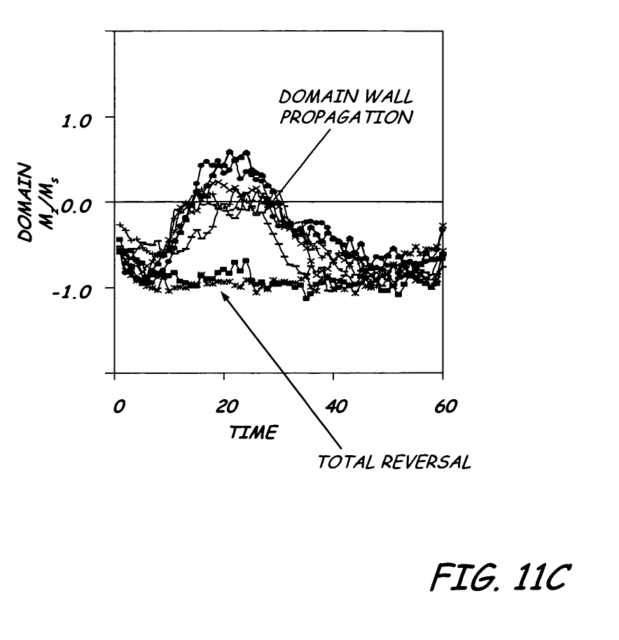

When the grain size is smaller than the domain wall width, then the reversal mode is coherent rotational, known as Stoner Wolfrath reversal. In that case, all the atomic spins within the grain reverse simultaneously, and the grain remains single domain even while reversing. When the grain size increases beyond a domain wall width, the grain 200 remains a single domain because the magnetostatic interaction is still small compared to the crystalline anisotropy. However, the reversal mode is no longer Stoner-Wolfrath reversal. Instead, the magnetization direction reverses by domain wall formation and propagation (as shown in FIG. 4). The reversal usually starts at the edge of the grain 200. A domain wall forms (as shown in FIG. 11B below). All of the atomic spins within the length of the domain wall reverse simultaneously, and over time the domain wall propagates until all the atomic spins in the grain are reversed (see FIG. 11C below). For the grain sizes of interest (such as magnetic grains of 3×3×20 nm³) in high density recording, the grains 200 are large enough to support more than one domain and domain wall. Nevertheless, the grains 200 remain single domain, and the reversal mode is by domain wall formation and propagation.

FIG. 6 is a simplified cross-sectional view of a portion of a data storage medium 600 for use in perpendicular recording (such as disc platter 107 in FIG. 1). The medium 600 includes a substrate 602, a heat sink layer 604, a ferromagnetic layer 606, an overcoat layer 608 and a lubricant layer 610. The substrate is typically formed of a low-density, rigid and low cost material, such as aluminum. The heat sink layer 604 is disposed on the substrate 602 and draws heat away from the ferromagnetic layer 606 once the heat source is removed. The heat sink layer 604 prevents lateral flow of heat. The ferromagnetic layer 606 is formed from a plurality of elongate grains 200 arranged perpendicular to the substrate 602, such that the perpendicular height (H) (relative to the substrate) is greater than the horizontal width (W). Each of the elongate grains 200 is separated from adjacent grains 200 within the ferromagnetic layer 606 by an air gap 612 introduced by co-sputtering the ferromagnetic material with, for example, a Nickel-Oxygen material. The overcoat 608 and lubricant 610 provide corrosion and contact protection for the ferromagnetic layer 606, and reduce friction and wear between the overcoat layer 606 and read-write mechanisms, such as transducing head 110 in FIG. 1.

Depending on the specific implementation, other layers may also be included between the substrate 602 and heat sink layer 604, and between the heat sink layer 604 and the ferromagnetic layer 606. For example, a layer of ruthenium can be disposed between the ferromagnetic layer 606 and the heat sink layer 604. Additionally, a seed layer can be added between the ferromagnetic layer 606 and the heat sink layer 604. Moreover, a very thin ruthenium layer can be used between two or more soft magnetic layers to create anti-ferromagnetic coupling between soft magnetic layers, reducing the formation of magnetic domains in the ferromagnetic layer 606.

It should be understood by workers skilled in the art that the data storage medium 600 in FIG. 3 is one type of recording medium having a ferromagnetic layer 606 formed of such elongate grains 200. However, other recording media having different layers around the ferromagnetic layer 606 can also be used. The embodiment of FIG. 3 is provided for the purpose of illustration only.

FIG. 7 illustrates a partial sectional view of an example storage medium/transducer interface 700 for perpendicular recording by a read/write transducer 702 to a medium 107 for use in the present invention. Read/write transducer 702 includes a writing element 706 and a reading element 708 formed on a trailing edge of a slider (not shown). Reading element 708 includes a read sensor 710 that is spaced between a top shield 712 and a bottom shield 714. Top and bottom shields 712 and 714 operate to isolate read sensor 710 from external magnetic fields that could affect sensing bits of data that have been recorded on data storage medium 107.

Writing element 706 includes a writing main pole 716 and a return pole 718. Main and return poles 716 and 718 are separated a non-magnetic spacer 720. Main pole 716 and return pole 718 are connected at a back gap closure 722. A conductive coil 724 extends between main pole 716 and return pole 718 and around back gap closure 722. An insulating material (not shown) electrically insulates conductive coil 724 from main and return poles 716 and 718. Main and return poles 716 and 718 include main and return pole tips 726 and 728, respectively, which face a surface 730 of data storage medium 107 and form a portion of an air bearing surface (ABS) 732 of a slider. While reading element 708 is shown with separate top and bottom shields 712 and 714 from writing element 706. However, it should be noted that in other read/write transducers, return pole 718 could operate as a top shield for reading element 708.

A magnetic circuit is formed in writing element 706 by main and return poles 716 and 718, back gap closure 722, and a soft magnetic layer 734 of data storage medium 107 which underlays a hard magnetic or storage layer 736 having perpendicular orientation of magnetization. Storage layer 736 includes uniformly magnetized domains 504,506, each of which represent a bit of data in accordance with an up or down orientation. Adjacent domains 504,506 are separated from one another by domain walls 502. In operation, an electrical current is caused to flow in conductive coil 724, which induces a magnetic flux that is conducted through the magnetic circuit. The magnetic circuit causes the magnetic flux to travel vertically through the main pole tip 726 and storage layer 736 of the recording medium, as indicated by arrow 740. Next, the magnetic flux is directed horizontally through soft magnetic layer 734 of the recording medium, as indicated by arrow 742, then vertically back through storage layer 736 through return pole tip 728 of return pole 718, as indicated by arrow 744. Finally, the magnetic flux is conducted back to main pole 716 through back gap closure 722.

Main pole tip 726 is shaped to concentrate the magnetic flux traveling therethrough to such an extent that the orientation of magnetized domains 504,506 of storage layer 736 are forced into alignment with the writing magnetic field and, thus, cause bits of data to be recorded therein. In general, the magnetic field in storage layer 736 at main pole tip 726 must be twice the coercivity or saturation field of that layer. Data storage medium 107 rotates in the direction indicated by arrow 746. A trailing edge 748 of main pole 716 operates as a “writing edge” that defines the transitions (domain walls 502) between bits of data recorded in storage layer 736, since the field generated at that edge is the last to define the magnetization orientation in the pattern 504,506.

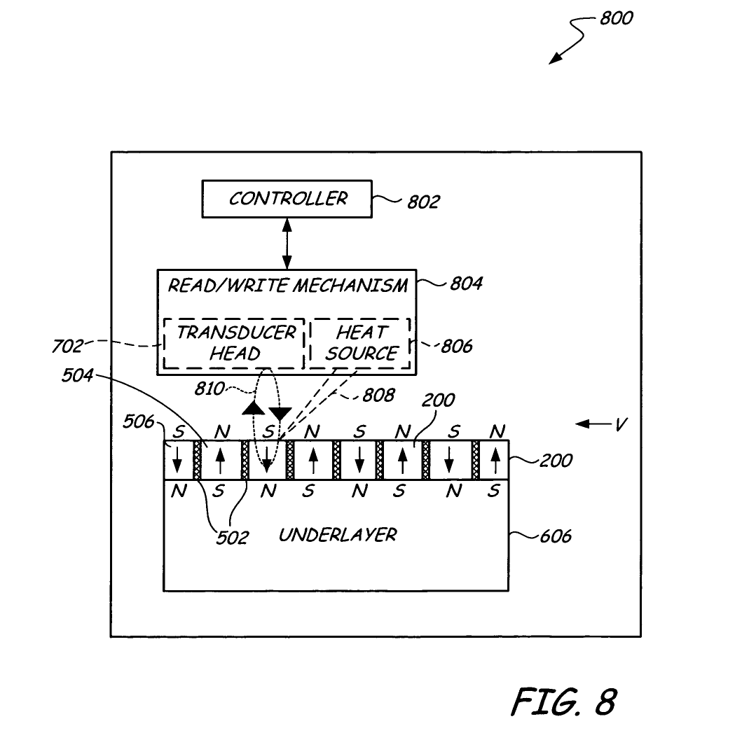

FIG. 8 is a simplified block diagram of a data storage device 800 with a controller 802 and a read/write mechanism 804 for reading and writing data from and to storage medium 107. The read/write mechanism 804 includes a transducer head 702 (such as shown in FIG. 7) for perpendicular recording. Additionally, the read/write mechanism 804 includes a heat source 806 for heating selected grains 200 of the ferromagnetic layer 606 in the proximity of magnetic field 810 from the transducer head 702. For example, the heat source 806 can produce an optical beam 808 for heating the layer 606. The applied heat from the beam 808 lowers the anisotropy of the selected grains 200 so that the applied magnetic field 810 can alter a magnetic direction of one or more the grains 200. Each grain 200 is separated from the next adjacent grain 200 by a respective air gap 612. Uniformly magnetized grains 200 define domains 504,506 separated by domain walls 502. Each domain wall 502 has a domain wall thickness (L_{dw}). In a preferred embodiment, a majority of the magnetic grains 200 have a height (H) that is greater than the domain wall thickness (L_{dw}).

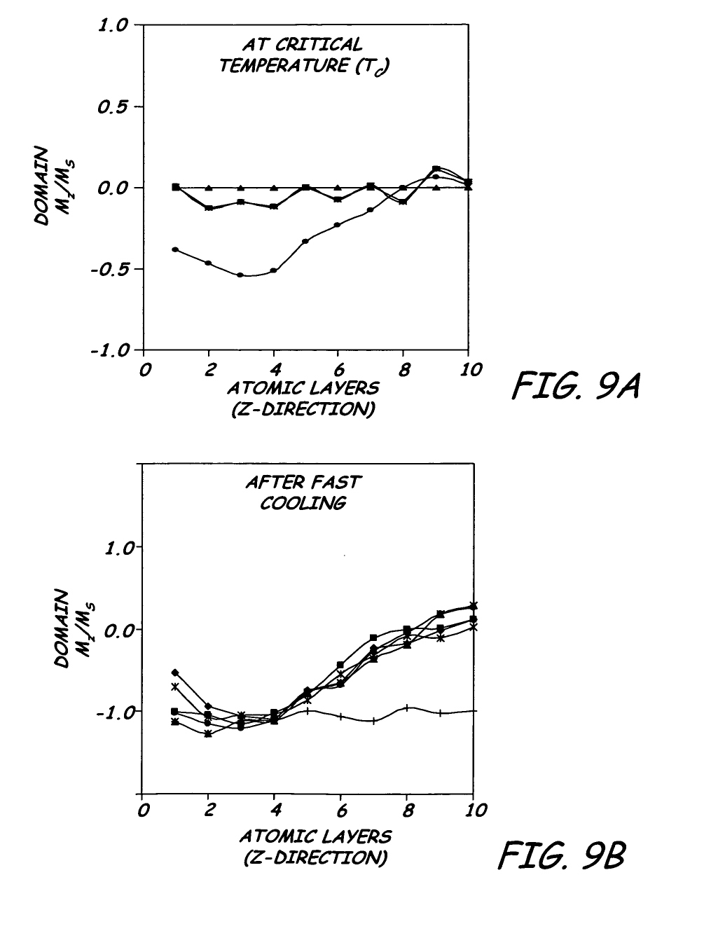

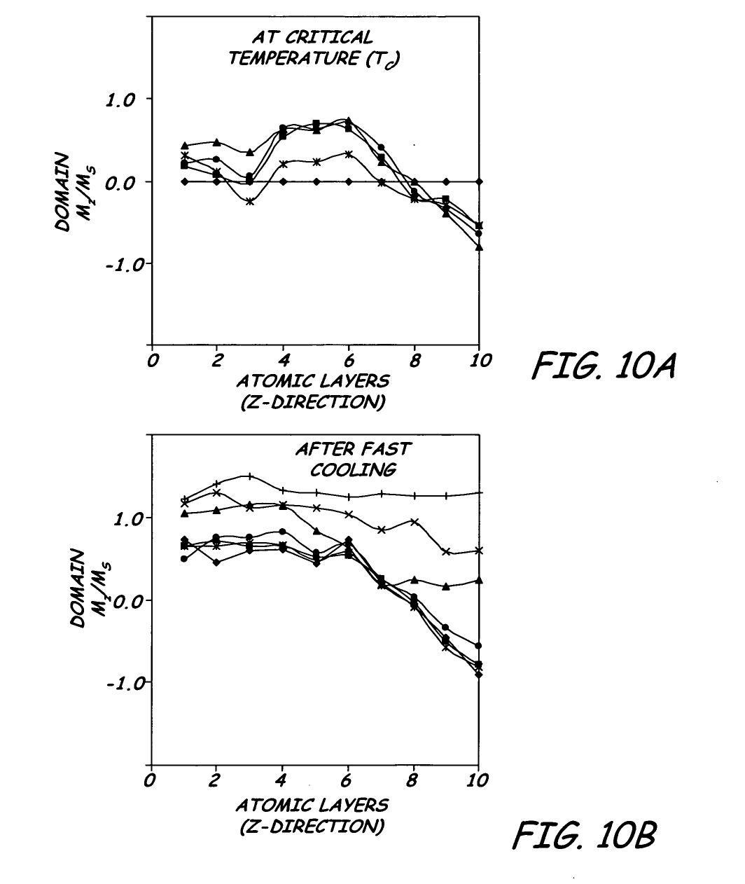

FIGS. 9A-10B, the evolution of the z-component of magnetization is plotted with respect to atomic layers in the z-direction. The crystalline anisotropy of the grain 200 is along the z-direction. Magnetization (Mz) represents the average magnetization of all the atoms in the same z-plane. The value (Ms) represents the saturation value of the z-component magnetization at room temperature. The external field (Hₑₓₜ) is applied in the negative direction, such that when the magnetization is negative, the magnetization is in the direction of the external field. The evolution is monitored as the temperature is reduced from the critical temperature (Tc) to room temperature.

Generally, FIGS. 9A and 10A correspond to smaller time scales than FIGS. 9B and 10B. In FIGS. 9A-10B, the grain size is approximately 10×10×10 atoms, which is smaller than the domain wall width (L_{dw}), which is approximately 20 atoms. Since the nature of the evolution is statistical, it is depicted for two configurations for illustrative purposes.

Initially when the spin temperature is near the critical temperature (Tc), the magnetization of the grain is close to zero. FIGS. 9A and 9B show that though the magnetization is close to zero, the magnetization of the individual grains is not uniform. Instead, the magnetization of individual grains experience spatial fluctuations.

As illustrated in FIGS. 9B and 10B, as the system is cooled, the average magnetization increases (relative to the magnetization shown in FIGS. 9A and 10A) such that the fluctuations grow into larger domains. Comparing FIGS. 9A and 9B for example, the initial negative fluctuations in FIG. 9A grow into larger negative domains.

In general, FIGS. 9A-10B show that the initial fluctuations determine the final state of the system. If the initial fluctuations are in the direction of the external field as shown in configuration FIG. 9A, then the final state is the reversed state shown in FIG. 9B. Whereas if the initial thermal fluctuation is opposite to the external field as shown in FIG. 10A, then the final state is not reversed as shown in FIG. 10B.

In both the cases, the external field (Hₑₓₜ) was approximately ¼th of the reversal field at room temperature, such that the ratio of the applied external field to the reversal field was Hₑₓₜ/H_{K0}=0.25. This behavior relative to the initial fluctuations leads to a superparamagnetic trap wherein the external field does not affect the final state of the system. Thus, as shown above in Table 1, approximately 50 percent of the configurations are reversed, resulting in a net magnetization of zero averaged over all of the configurations.

For grains sizes larger than a domain wall width (L_{dw}), nucleation of more than one domain is possible without costing too much exchange energy. As long as one domain with spins pointing in the direction of the external field is stabilized, the domain expands under the influence of the external field until the magnetization direction of the grain reverses.

In FIGS. 11A-11C, the effect is shown of increasing the grain height to 60 atoms, which is greater than the domain wall width of approximately 20 atoms. FIGS. 11A-11C illustrate that multiple domains can nucleate. As long as one nucleation center in the direction of the external field (Hₑₓₜ) is stabilized (meaning that the nucleation center reaches sizes above a critical size sustainable by the exchange), the domain grows under the action of external field (Hₑₓₜ). Over time, the magnetization direction of the grain reverses by domain wall formation and propagation. Even in configurations where the initial fluctuations in the direction opposite to the external field were large, the final state can be the reversed state.

In FIG. 11A, the largest domain is shown in the opposite direction of the external field (Hₑₓₜ). Additionally, the grain allows for multiple domains, as shown. In FIG. 11B the stabilized domain in the direction of the external field (Hₑₓₜ) begins to expand under the action of the external field. A domain wall is formed between the stabilized domain and the larger domain. FIG. 11C shows propagation of the domain wall formed in FIG. 11B and total reversal of the largest domain. Reversal occurs when the largest domain is in the opposite direction.

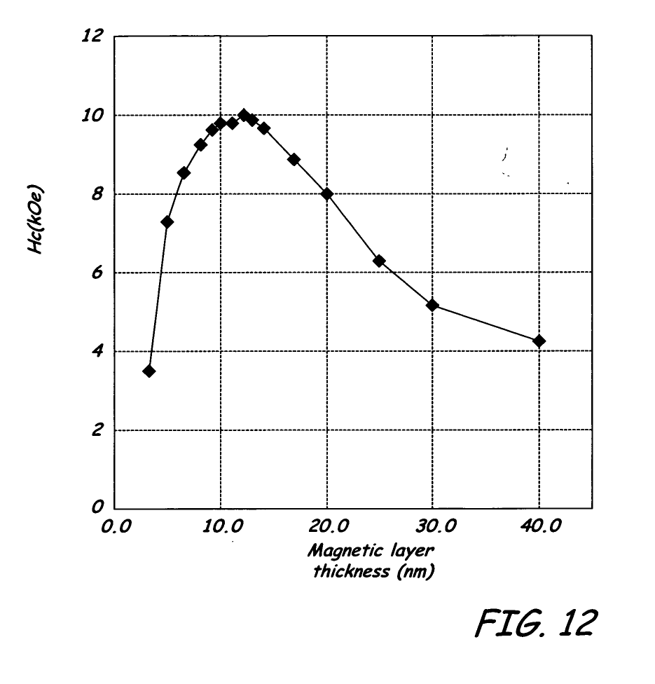

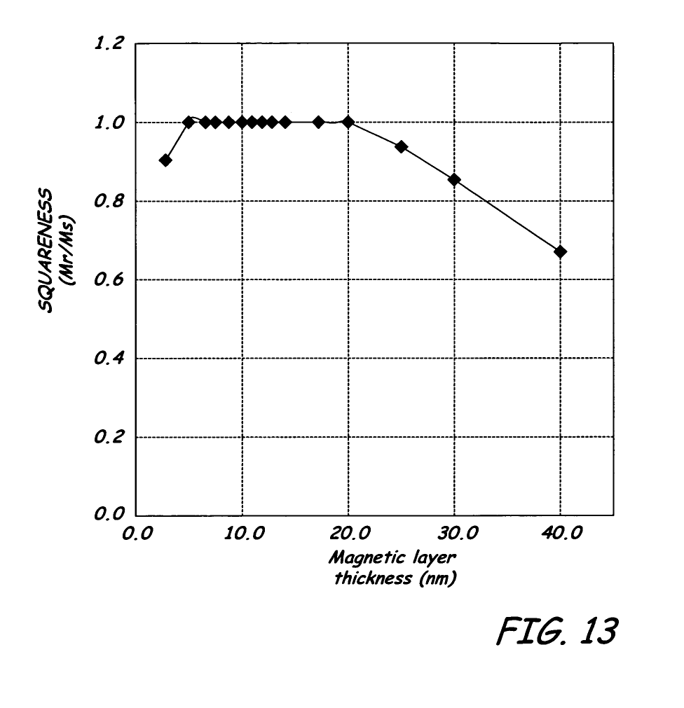

FIG. 12 illustrates the coercivity versus magnetic layer thickness for a series of media fabricated with different thicknesses. The magnetic grains of the media were formed in a columnar shape and potential-well decoupled by Nickel-Oxygen (NiO) by co-sputtering the CoPt alloy with NiO onto the soft underlayer of the media. In this instance, the A series of media with various magnetic layer thickness have been fabricated. The magnetic grains are in columnar shape and well decoupled by NiO by co-sputtering the CoPt alloy with NiO. In this instance, the media 107 had a substrate 302 formed from glass, a decoupling layer formed from Tallium (2 nm), a Platinum seed layer (4 nm), a Ruthenium soft underlayer 304 (60 nm), a ferromagnetic layer 306 formed by co-sputtering the CoPt alloy with NiO to form columnar magnetizable grains of varying thickness, and a carbon overcoat layer 308 formed (7 nm).

The coercivity (Hc) of the sample varies with the thickness of the magnetic layer. The coercivity (Hc) increases up to a magnetic layer thickness of about 10 nm, due to the shape anisotropy and thermal stability introduced by the elongated grain. However, when the magnetic layer thickness is increased further, the coercivity falls off. As the thickness increases, the magnetization direction switching mechanism is dominated by non-coherent switching, due to a lack of thermal stability.

FIG. 12 is a graph of squareness versus magnetic layer thickness. The media maintains full squareness between 5 nm and 20 nm. As the magnetic layer thickeness increases beyond 20 nm, the media can no longer maintain the full squareness. This strongly suggests that extra long columnar grains have no-coherent switching. This may be due to the fact that the longer grains lower the magnetic hardness so much that the demagnetization field can switch some of the grains.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the data storage medium and the associated heat-assisted data storage system while maintaining substantially the same functionality without departing from the scope and spirit of the present invention. In addition, although the preferred embodiment described herein is directed to a storage medium formed from high anisotropy elongate grains arranged perpendicular to a substrate for use in heat-assisted data storage devices, it will be appreciated by those skilled in the art that the teachings of the present invention can be applied to other types of storage devices, without departing from the scope and spirit of the present invention.

What is claimed is:

1. A data storage medium for perpendicular recording comprising:
a substrate; and
a ferromagnetic layer on the substrate for storing data bits, the ferromagnetic layer comprising a plurality of elongate grains of magnetizable material extending perpendicular to the substrate which form a plurality of magnetic domains representative of data, each magnetic domain separated from an adjacent magnetic domain by a bit edge domain wall region, wherein the elongate grains in the magnetic domains have a perpendicular height that is greater than a width of the bit edge domain wall region.

2. The data storage medium of claim 1 wherein the width of the bit edge domain wall region (L_{dw}) is related to a ratio of an exchange constant (J) and a crystalline anisotropy (k) of the magnetizable material

3. The data storage medium of claim 1 wherein a direction of magnetization of each grain changes by propagation of a domain wall within the grain.

4. The data storage medium of claim 1 wherein the magnetizable material comprises Iron-Platinum alloy (FePt).

5. The data storage medium of claim 1 wherein the magnetizable material comprises Cobalt-Platinum alloy (CoPt).

6. A data storage device comprising:
a data storage medium according to claim 1, wherein the magnetizable material has a high anisotropy; and
read-write mechanism comprising a heat source adapted to heat the data storage medium to reduce the high anisotropy property of selected grains and a transducer head adapted to write data to the selected grains.

7. A heat-assisted data storage device comprising:
a data storage medium having a ferromagnetic layer formed from a plurality of grains of a magnetizable material with high anisotropy extending perpendicular to a substrate layer and which form a plurality of magnetic domains, each magnetic domain separated from an adjacent magnetic domain by a bit edge domain wall region, wherein grains in the magnetic domains have a perpendicular height that is greater than a width of the domain wall region; and
a heat-assisted read-write mechanism adapted to heat the ferromagnetic layer to reduce the anisotropy for writing data to the data storage medium.

8. The heat-assisted data storage device of claim 7 wherein the heat-assisted read-write mechanism comprises:
a heat source adapted to heat the ferromagnetic layer to lower the anisotropy; and
a transducer head adapted to write data to selected grains of the plurality of grains by altering an associated magnetic orientation responsive to data.

9. The heat-assisted data storage device of claim 8 wherein the selected grains change the associated magnetic orientation by domain wall motion within each of the selected grains responsive to a magnetic field applied by the transducing head.

10. The heat-assisted data storage device of claim 7 wherein the material comprises a Cobalt-Platinum alloy.

11. The heat-assisted data storage device of claim 7 wherein each grain of the plurality of grains has a height that is greater than a width of the grain.

12. The heat-assisted data storage device of claim 7 wherein a width of the bit edge domain wall region is related to an exchange constant (J) and a crystalline anisotropy (k) of the material, wherein the domain wall width (L_{dw}) is approximately equal to
$$π * \sqrt{\frac{J}{K}} .$$

13. The heat-assisted data storage device of claim 7 wherein the height of each grain is approximately 20 nm and a width of each elongate grain is approximately 3 nm.

14. A data storage medium comprising:
a substrate;
a ferro-magnetic layer on the substrate comprising a plurality of columnar grains extending perpendicular to the substrate which form a plurality of magnetic domains, each grain formed from a magnetizable material with a high anisotropy, each grain having a perpendicular height that is greater than its horizontal width and greater than a domain wall width of a magnetic domain.

15. The data storage medium of claim 14 wherein magnetization of each columnar grain changes an associated direction of magnetization by domain wall motion within the columnar grain.

16. The data storage medium of claim 14 wherein the domain wall width (I_{dw}) is approximately equal to
$$π * \sqrt{\frac{J}{K}} ,$$
where J comprises the material exchange constant and K comprises the crystalline anisotropy of the ferromagnetic layer.

17. The data storage medium of claim 14 wherein the data storage medium exhibits a squareness ratio of approximately one for grains formed with a magnetic layer thickness of between 5 and 20 nanometers.

18. The data storage medium of claim 17 wherein the material comprises an Iron-Platinum alloy.

19. The data storage medium of claim 14 wherein each grain of the plurality of columnar grains is separated from a respective other grain by oxygen.

20. The data storage medium of claim 14 wherein each grain of the plurality of columnar grains is larger than a single domain size, wherein each grain supports multiple domains that nucleate in a direction of an external field.
